(19) United States
(12) Patent Application Publication
(10) Pub. No.: US 2024/0217841 A1
(43) Pub. Date: Jul. 4, 2024

(54) METHOD OF MANUFACTURING POSITIVE ELECTRODE ACTIVE MATERIAL, AND POSITIVE ELECTRODE ACTIVE MATERIAL

(71) Applicant: TOYOTA JIDOSHA KABUSHIKI KAISHA, Toyota-shi (JP)

(72) Inventor: Yosuke TOKUDA, Susono-shi (JP)

(73) Assignee: TOYOTA JIDOSHA KABUSHIKI KAISHA, Toyota-shi (JP)

(21) Appl. No.: 18/530,299

(22) Filed: Dec. 6, 2023

(30) Foreign Application Priority Data
Dec. 28, 2022 (JP) 2022-212515

(51) Int. Cl. C01G 53/00

(52) U.S. Cl. CPC C01G 53/50; C01P 2006/40

(57) ABSTRACT

Disclosed is a method for improving cycling characteristics and rate characteristics of O2 type positive electrode active material. The method of manufacturing a positive electrode active material according to the present disclosure includes: obtaining a first compound including at least one element of Mn, Ni and Co; mixing the first compound, a second compound including Na and a third compound including at least one element M selected from B, Mg, Al, K, Ca, Ti, V, Cr, Cu, Zn, Ga, Ge, Sr, Y, Zr, Nb, Mo and W, to obtain a mixture; firing the mixture to obtain Na-containing oxide having a P2 type structure; and ion-exchanging at least a portion of Na of the Na-containing oxide to Li to obtain a Li-containing oxide having an O2 type structure.

### TECHNICAL FIELD

The present application discloses a positive electrode active material and a method of manufacturing the same.

### BACKGROUND ART

A positive electrode active material having an O2 type structure is known. A positive electrode active material with an O2-type structure can be obtained by ion-exchange of Li for at least a portion of the Na in a Na-containing transition metal oxide with a P2-type structure, as disclosed in PTL 1.

### CITATION LIST

### Patent Literature

[PTL 1] JP 2014-186937 A

### SUMMARY

### Technical Problem

Conventional positive electrode active materials having O2 type structures have room for improvement in terms of capacity, cycling properties and rate properties.

### Solution to Problem

As a means for solving the above problem, the present application discloses the following plurality of aspects.

### <Aspect 1>

A method of manufacturing a positive electrode active material, the method comprising:
obtaining a first compound including at least one element of Mn, Ni and Co;
mixing
   the first compound,
   a second compound including Na and
   a third compound including at least one element M selected from B, Mg, Al, K, Ca, Ti, V, Cr, Cu, Zn, Ga, Ge, Sr, Y, Zr, Nb, Mo and W,
to obtain a mixture;
firing the mixture to obtain a Na-containing oxide having a P2 type structure; and
ion-exchanging at least a portion of Na of the Na-containing oxide to Li to obtain a Li-containing oxide having an O2 type structure.

### <Aspect 2>

The method according to claim 1, the method comprising:
obtaining a precipitate as the first compound by a co-precipitation method using an ion source and a transition metal compound, wherein the ion source is capable of forming a precipitate with transition metal ions in an aqueous solution.

### <Aspect 3>

The method according to claim 1, wherein
the first compound is a salt including at least one element of Mn, Ni and Co,
the second compound is a salt including Na, and
the third compound is a salt including the element M.

### <Aspect 4>

The method according to claim 1, wherein
the Li containing oxide has a chemical composition represented by LiₐNa_{b}Mnₓ₋ₚNi_{y-q}Co_{z-r}M_{p+q+r}O₂ (where, 0<a≤1.00, 0≤b≤0.20, x+y+z=1, 0.03≤p+q+r<0.17).

### <Aspect 5>

A positive electrode active material having an O2 type structure, wherein
the positive electrode active material has a chemical composition represented by LiₐNa_{b}Mnₓ₋ₚNi_{y-q}CO_{z-r}M_{p+q+r}O₂ (where, 0<a≤1.00, 0≤b≤0.20, x+y+z=1, 0.03≤p+q+r<0.17, M is at least one selected from B, Mg, Al, K, Ca, Ti, V, Cr, Cu, Zn, Ga, Ge, Sr, Y, Zr, Nb, Mo and W), and
the ratio of aggregation areas of the element M occupying a surface of the positive electrode active material is less than 0.01 mm² per 1.00 mm² of the surface.

### Effects

The positive electrode active material of the present disclosure has high capacity, cycling characteristics and rate characteristics.

### BRIEF DESCRIPTION OF DRAWINGS

FIG. 1 shows an example of a flow of a method of manufacturing a positive electrode active material.

FIG. 2 schematically shows an example of the configuration of a lithium ion battery.

FIG. 3 shows the X-ray diffraction pattern of the positive electrode active material.

FIGS. 4A-D show SEM image and EDX image of the positive electrode active material.

### DESCRIPTION OF EMBODIMENTS

### 1. Method of Manufacturing Positive Electrode Active Material

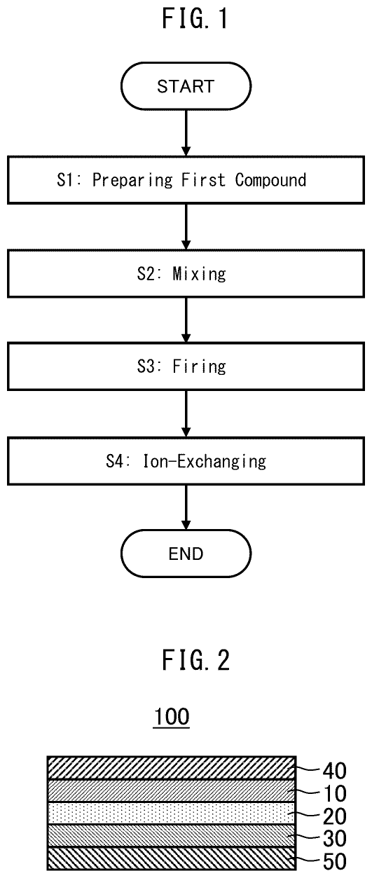

As shown in FIG. 1, a method of manufacturing a positive electrode active material according to an embodiment includes: obtaining a first compound including at least one element of Mn, Ni and Co (Step S1); mixing the first compound, a second compound including Na and a third compound including at least one element M selected from B, Mg, Al, K, Ca, Ti, V, Cr, Cu, Zn, Ga, Ge, Sr, Y, Zr, Nb, Mo and W, to obtain a mixture (Step S2); firing the mixture to obtain a Na-containing oxide having a P2 type structure (Step S3); and ion-exchanging at least a portion of Na of the Na-containing oxide to Li to obtain a Li-containing oxide having an O2 type structure (Step S4).

### 1.1 Step S1

In the step S1, a first compound including at least one element of Mn, Ni and Co is obtained. The first compound may be, for example, a salt comprising at least one element of Mn, Ni and Co. Specifically, the first compound may be at least one of carbonate, sulfate, nitrate and acetate. Alternatively, the first compound may be a compound other than a salt. For example, the first compound may be a hydroxide. The first compound may be a combination of a plurality of types of compounds. The first compound does not contain an element M described later. The first compound may be in various shapes. For example, the first compound may be particulate. The particle diameter of the particles composed of the first compound is not particularly limited.

In the step S1, a precipitate as the first compound may be obtained by a co-precipitation method using an ion source and a transition metal compound, wherein the ion source is capable of forming a precipitate with transition metal ions in an aqueous solution. The “ion source capable of forming a precipitate with transition metal ions” may be, for example, at least one selected from sodium salts such as sodium carbonate and sodium nitrate, sodium hydroxide, and sodium oxide. The transition metal compound may be a salt, a hydroxide, or the like described above. Specifically, in the step S1, a precipitate may be obtained by dropping and mixing each solution after the ion source and the transition-metal compound are each used as a solution. At this time, for example, water is used as the solvent. At this time, various sodium compounds may be used as the base, and an aqueous ammonia solution or the like may be added to adjust the basicity. In the case of the co-precipitation method, for example, an aqueous solution of a transition metal compound and an aqueous solution of sodium carbonate are prepared, and each aqueous solution is added dropwise and mixed to obtain a precipitate as the first compound. Alternatively, it is also possible to obtain the first compound by a sol-gel method. Especially according to the co-precipitation method, as the first compound, it is easy to obtain a particulate and spherical. As described above, the first compound does not contain an element M. In the manufacturing method of the present disclosure, the element M is not added at the time of co-precipitation synthesis of the first compound. And when Na doping and firing is performed on the first compound in the step S2 and S3 described later, the element M is doped.

### 1.2 Step S2

In step S2, the first compound obtained by step S1, a second compound containing Na, and a third compound containing at least one element M selected from B, Mg, Al, K, Ca, Ti, V, Cr, Cu, Zn, Ga, Ge, Sr, Y, Zr, Nb, Mo and W are mixed to obtain a mixture. The second compound may be, for example, a salt containing Na such as a carbonate or a sulfate, or a compound other than a salt such as sodium oxide or sodium hydroxide. The third compound may be, for example, a salt containing an element M such as a carbonate or a sulfate, or a compound other than a salt such as an oxide or a hydroxide.

The quantity of the second compound to be mixed with respect to the first compound may be determined by taking into consideration Na loss during subsequent firing. Further, the quantity of the third compound to be mixed with respect to the first compound may be determined according to the chemical composition of Na-containing oxide after firing. In the step S2, the first compound, the second compound, and the third compound described above may be mixed in a solid phase or mixed in a liquid phase. For example, particles comprised of the first compound, particles comprised of the second compound, and particles comprised of the third compound may be mixed by a mortar, a ball mill, or the like. In addition, in the step S2, the surface of the particles comprised of the first compound may be coated with the second compound or the third compound to obtain coated particles. The coated particles may be obtained by coating the 40 area % or more, 50 area % or more, 60 area % or more or 70 area % or more of the surface of the particles of the first compound with the second compound and the third compound.

### 1.3 Step S3

In the step S3, the mixture obtained by step S2 is fired to obtain Na-containing oxide having a P2 type structure. In the step S3, the above-mentioned mixture may be optionally molded and optionally pre-fired and then the main firing may be performed. Pre-firing of the mixture may be performed at a temperature lower than or equal to the main firing. For example, it is possible to perform pre-firing at a temperature less than 700° C. The pre-firing time is not particularly limited. Alternatively, pre-firing may be omitted.

In the step S3, the main firing of the mixture may be performed, for example, at a temperature of 700° C. or higher and 1100° C. or lower. It is preferably 800° C. or higher and 1000° C. or lower. If the main firing temperature is too low, Na doping is not performed, and if the main firing temperature is too high, 03 type structure rather than P2 type structure is likely to be generated. The temperature rising condition from the pre-firing temperature to the main firing temperature is not particularly limited. The main firing time is also not particularly limited, and may be, for example, 30 minutes or more and 48 hours or less. The main firing atmosphere is also not particularly limited, and may be, for example, an oxygen containing atmosphere such as an air atmosphere or an inert gas atmosphere.

The Na-containing oxide obtained by the step S3 includes, as a constituent element, at least one element of Mn, Ni and Co, Na, the element M, and O. In particular, when including at least, Na, Mn, at least one of Ni and Co, the element M and O, in particular, when including at least, Na, Mn, Ni, Co, the element M and O as constituent elements, the performance of the positive electrode active material tends to be high. More specifically, the Na-containing oxide obtained by the step S3 may have a chemical composition represented by Na_{c}Mnₓ₋ₚNi_{y-q}Co_{z-r}M_{p+q+r}O₂ (where, 0<c≤1.00, x+y+2=1, 0.03≤p+q+r<0.17). When the Na-containing oxide has such a chemical composition, P2 type structure is easily maintained. In the above chemical composition, c is more than 0, and may be 0.10 or more, 0.20 or more, 0.30 or more, 0.40 or more, 0.50 or more, or 0.60 or more, and is 1.00 or less, and may be 0.90 or less, 0.80 or less, or 0.70 or less. Further, x is 0 or more, and may be 0.10 or more, 0.20 or more, 0.30 or more, 0.40 or more, or 0.50 or more, and is 1.00 or less, and may be 0.90 or less, 0.80 or less, 0.70 or less, 0.60 or less, or 0.50 or less. Further, y is 0 or more, and may be 0.10 or more or 0.20 or more, and is 1.00 or less, and may be 0.90 or less, 0.80 or less, 0.70 or less, 0.60 or less, 0.50 or less, 0.40 or less, 0.30 or less, or 0.20 or less. Further, z is 0 or more, and may be 0.10 or more, 0.20 or more, or 0.30 or more, and is 1.00 or less, and may be 0.90 or less, 0.80 or less, 0.70 or less, 0.60 or less, 0.50 or less, 0.40 or less, or 0.30 or less. The element M is small contribution to charge and discharge. In this regard, in the above chemical composition, p+q+r is less than 0.17, whereby it is easy to secure a high charge and discharge capacity. p+q+r may be 0.16 or less, 0.15 or less, 0.14 or less, 0.13 or less, 0.12 or less, 0.11 or less, or 0.10 or less. On the other hand, by containing the element M, it is easy to stabilize P2 type structure and O2 type structure. In this regard, in the chemical composition described above, p+q+r is 0.03 or more, and may be 0.04 or more, 0.05 or more, 0.06 or more, 0.07 or more, 0.08 or more, 0.09 or more, or 0.10 or more. The composition of O is almost 2, but is not limited to 2.0 just, and is nonstoichiometric.

### 1.4 Step S4

In the step S4, at least a part of Na of the Na-containing oxide obtained by the step S3 is exchanged to Li by ion-exchange to obtain a Li containing oxide having an O2 type structure. In the step S4, for example, at least a part of Na of the Na-containing oxide can be replaced with Li by ion-exchange using a lithium-salt. For example, the Na-containing oxide having a P2 type structure and a lithium salt are mixed and then heated to a temperature equal to or higher than a melting point of the lithium salt, the lithium salt is melted, whereby at least a part of Na can be replaced with Li by ion-exchange. The lithium salt may be, for example, lithium halide. The lithium halide is preferably at least one of lithium chloride, lithium bromide and lithium iodide. Alternatively, the lithium salt may be lithium nitrate. Alternatively, the lithium salt may be a mixed salt of lithium halide and lithium nitrate. When the mixed salt of lithium halide and lithium nitrate is used as the lithium salt, the smaller the amount of lithium halide, the lower the melting point of the mixed salt tends to be.

Temperature in the step S4 (for example, heating temperature in the case of carrying out melt ion-exchange after contacting a lithium salt to a Na-containing oxide particle) may be, for example, 600° C. or less, 500° C. or less, 400° C. or less, 350° C. or less, 300° C. or less, 280° C. or less, 250° C. or less, 230° C. or less, 200° C. or less, or 170° C. or less, and it may be above room temperature or 100° C. or more. If the temperature is too high, an O3 type structure which is a stable phase is easily generated rather than an O2 type structure. In this regard, it is preferable that the temperature in the step S4 is 280° C. or less. In addition, when the lithium salt is melted, it may be heated to a temperature higher than or equal to the melting point of the lithium salt as described above. The time in the step S4 (for example, the heating time when the lithium salt is heated and melted after being contacted with Na-containing oxide to perform ion-exchange) may be adjusted so that most of Na of the Na-containing oxide is replaced with Li. From the viewpoint of ensuring a sufficient time for the lithium salt to melt, for example, the time in the step S4 may be, for example, 10 minutes or more or 30 minutes or more, and may be 12 hours or less or 6 hours or less. The atmosphere in the step S4 is not particularly limited, and may be, for example, an oxygen containing atmosphere such as an air atmosphere or an inert gas atmosphere. After ion-exchange, some post-treatment such as cleaning may be performed on the Li-containing oxide having an O2 type structure.

### 1.5 Effect

Conventionally, when an element M is doped into a Li-containing oxide having an O2 type structure, an element M is simultaneously added when a first compound containing a transition metal such as Mn is obtained. For example, after obtaining a precursor containing at least one of Mn, Ni and Co and an element M, Na doping is performed on the precursor to obtain Na-containing oxide having a P2 type structure, and then the Na-containing oxide is ion-exchanged to obtain a Li-containing oxide having an O2 type structure. However, according to the findings of the present inventor, when the element M is added at the same time when the first compound is obtained, fine particles having the element M as a nucleus are generated, and the fine particles are easily aggregated on the surface of the finally obtained Li-containing oxide. It is considered that in the case of obtaining the first compound by the co-precipitation method, when co-precipitating the metal element in the aqueous solution as a salt, if the ionic radius of metal elements is close to each other, it is easy to replace each other, whereby uniform compounds are likely to be generated. For example, Mn, Ni and Co have close ionic radii, and thus tend to form uniform salts by co-precipitation. On the other hand, the element M, having ionic radius different as compared with that of Mn, Ni or Co, hardly forms a uniform salt with Mn, Ni and Co, i.e., at the time of co-precipitation, fine particles having nucleating element M are likely to occur separately from the salt of Mn, Ni and Co. It is considered that the fine particles containing the element M as a nucleus do not substantially contribute to the battery reaction, and contribute to lowering the capacity and the like of the positive electrode active material.

In contrast, in the manufacturing method of the present disclosure, the element M is not simultaneously added when the first compound is obtained in the step S1 and the element M is doped with Na when the Na doping is performed on the first compound in the step S2 and S3. Thus, it becomes difficult to produce fine particles with the element M as a nucleus, the aggregation of the element M is suppressed, and the element M is easily uniformly doped in the crystal structure of the positive electrode active material. By suppressing aggregation of the element M on the surface of the positive electrode active material, the area of deintercalation of Li ions in the positive electrode active material is increased, and the capacity and the like are improved. Further, by doping the element M with respect to the positive electrode active material, O2 type structure is stabilized, whereby O2 type structure is hardly collapsed even when repeated charge-discharge. Therefore, cycle characteristics and rate characteristics of the positive electrode active material is improved. Such an effect of suppressing the aggregation of the element M and of stabilizing the crystalline structure by the element M, is exhibited when the element M is at least one selected from B, Mg, Al, K, Ca, Ti, V, Cr, Cu, Zn, Ga, Ge, Sr, Y, Zr, Nb, Mo and W. Among them, when the element M is at least one selected from B, Mg, Al, K, Ca, Ti, V, Zn, Ga, Ge, Sr, Y, Zr, Nb, Mo and W, among which is one or both of Al and Mg, particularly when it is Al, it is likely to be more effective.

### 2. Positive Electrode Active Material

As described above, through the steps S1 to S4, it is possible to produce a positive electrode active material having an O2 type structure (Li-containing oxide having an O2 type structure) excellent in capacity, cycling characteristics and rate characteristics. The positive electrode active material may have, for example, the following characteristics.

### 2.1 Crystal Structure

The positive electrode active material of the present disclosure has at least an O2 type structure (belonging to the space group P63mc). The positive electrode active material may have an O2 type structure and a crystalline structure other than O2 type structure. Examples of the crystal structure other than O2 type structure include a T #2 type structure (belonging to a space group Cmca) and O6 type structure (belonging to a space group R-3m, and differing from an O3 type structure having c-axis length of 2.5 nm or more and 3.5 nm or less, typically 2.9 nm or more, and also belonging to a space group R-3m), and the like. The positive electrode active material may be one having an O2 type structure as a main phase or one having a crystalline structure other than O2 type structure as a main phase, but particularly, one having an O2 type structure as a main phase is preferred. The positive electrode active material may be one in which the crystal structure serving as a main phase changes depending on the charge and discharge state thereof.

### 2.2 Chemical Composition

The positive electrode active material of the present disclosure includes at least one element selected from Mn, Ni and Co; Li; the element M; and O as constituent elements. In particular, when containing as a constituent element, at least: Mn; at least one of Ni and Co; Li; an element M; and O, especially when containing as a constituent element, at least, Mn, Ni, Co, Li, an element M and O, higher performance is easily ensured. In addition, the positive electrode active material may contain Na as a constituent element due to the above-described manufacturing process. Further, the positive electrode active material may contain other impurity elements. Specifically, the positive active material may have a chemical composition represented by LiₐNa_{b}Mnₓ₋ₚNi_{y-q}CO_{z-r}M_{p+q+r}O₂ (where, 0<a≤1.00, 0≤b≤0.20, x+y+z=1, 0.03≤p+q+r<0.17). In the chemical composition, “a” is more than 0, and may be 0.10 or more, 0.20 or more, 0.30 or more, 0.40 or more, 0.50 or more, or 0.60 or more. In addition, “b” is 0 or more, and may be more than 0, and is 0.20 or less, and may be 0.15 or less, 0.10 or less, 0.05 or less, 0.04 or less, 0.03 or less, 0.02 or less, or 0.01 or less. x, y, z, p, q and r, and the composition of O may be the same as those exemplified as the chemical composition of Na-containing oxide having a P2 type structure obtained in the above step S3, and will not be described here. In the prior art, when p+q+r is 0.03 or more, a problem related to aggregation of fine particles containing the element M tends to occur. In contrast, according to the positive electrode active material of the present disclosure, even if p+q+r is 0.03 or more, aggregation of fine particles can be suppressed. Further, in the above chemical composition, when the valence of the element M is set to +n, a relation of 3.0≤4(x−p)+2(y−q)+3(z−r)+n(p+q+r)≤3.5 may be satisfied. It is intended that the total valence of the metal in Li content oxide be close to 3.33 valence (charge-neutral when a is 0.67). As described above, the Li-containing oxide having an O2 type structure passes through the Na-containing oxide having a P2 type structure at the time of synthesizing the same. In the case where the above relation is satisfied, Na composition of the oxide becomes charge-neutral within a range of 0.5 or more and 1.0 or less.

### 2.3 Aggregated Region of Element M

The positive electrode active material of the present disclosure includes the element M as in the above chemical composition, and less aggregated areas of the element M on its surface. For example, the ratio of the aggregation areas of the element M occupying the surface of the positive electrode active material is less than 0.01 mm² per 1.00 mm² of the surface. As described above, the conventional positive electrode active material has an aggregation region of the element M on its surface, and the ratio of the aggregation region greatly exceeds 0.01 mm² per 1.00 mm² of the active material surface. In contrast, in the positive electrode active material of the present disclosure, the ratio of the aggregation region is less than 0.01 mm² per 1.00 mm² of the active material surface, that is, it has substantially no aggregated region on the surface of the positive electrode active material. Therefore, the positive electrode active material of the present disclosure has excellent capacity and rate characteristics, and the like. In addition, the positive electrode active material of the present disclosure has the above-described crystal structure and chemical composition, so that it is excellent in cycle characteristics.

“The ratio of the aggregation area of the element M occupying the active material surface” can be easily specified by observing the surface of the positive electrode active material with a SEM and analyzing the element distribution of the surface with EDX. As used herein, the term “aggregated region of an element M” refers to a region in which an element M is observed by aggregation when an element is mapped on an active material surface by SEM-EDX, and the region having an area circle equivalent diameter of 0.1 μm or more (fine particles).

### 2.4 Shape

The positive electrode active material of the present disclosure may be particulate. The positive electrode active material particles may be solid particles, and may be hollow particles, and may be those having a void. The positive electrode active material particles may be primary particles or secondary particles in which a plurality of primary particles are aggregated. The average particle diameter (D50) of the positive electrode active material particles may be, for example, 500 nm or more, 800 nm or more, 1 μm or more or 2 μm or more, and 500 μm or less, 100 μm or less, 50 μm or less or 30 μm or less. The average particle diameter D50 as referred to in the present application is the particle diameter (median diameter) at an integrated value of 50% in the particle size distribution on a volume basis measured by a laser diffraction/scattering method.

### 3. Method of Manufacturing Lithium Ion Battery

The positive electrode active material produced as described above is used, for example, as a positive electrode active material of a lithium ion battery. A method of manufacturing a lithium ion battery may include, for example, manufacturing a positive electrode active material by the manufacturing method of the present disclosure described above, obtaining a positive electrode active material layer using the manufactured positive electrode active material, and using the positive electrode active material layer to obtain a lithium ion battery. The method of manufacturing a lithium ion battery of the present disclosure may be the same method as in the prior art, except that a positive electrode active material layer is obtained using the specific positive electrode active material. For example, a method described in PTL (JP 2014-186937 A) or JP 2021-068556 A or the like may be employed.

### 4. Lithium Ion Battery

The technique of the present disclosure also has aspects as a lithium ion battery. For example, as shown in FIG. 2, a lithium ion battery 100 according to an embodiment has a positive electrode active material layer 10, an electrolyte layer 20, and a negative electrode active material layer 30, and the positive electrode active material layer 10 includes the positive electrode active material of the present disclosure described above. As shown in FIG. 2, the lithium ion battery 100 may include a positive electrode current collector 40 and a negative electrode current collector 50. In the lithium ion battery 100, a configuration other than the positive electrode active material may be the same as in the prior art. For example, the configuration described in PTL 1 (JP 2014-186937 A) and JP 2021-068556 A can be adopted.

### EXAMPLES

As described above, an embodiment of a method of manufacturing a positive electrode active material of the present disclosure has been described, but various modifications can be made to the method of the present disclosure other than the above embodiment without departing from the gist thereof. Hereinafter, the technique of the present disclosure will be described in further detail with reference to Examples, but the technique of the present disclosure is not limited to the following Examples.

### 1. Preparation of Positive Electrode Active Material

### 1.1 Example 1

### 1.1.1 Preparation of First Compound (Co-Precipitation Synthesis)

Mn(NO₃)₂·6H₂O, Ni(NO₃)₂·6H₂O, and Co(NO₃)₂·6H₂O as raw materials were dissolved in pure water so that the molar ratio of Mn, Ni and Co was 5:2:2 to obtain a first solution. On the other hand, Na₂CO₃ was dissolved in pure water so as to have a concentration 12 wt % to obtain a second solution. The first solution and the second solution were dropped into a beaker at the same time, and the first compound was co-precipitated and synthesized. At this time, the dropping rate was controlled so that pH was 7.0 or more and less than 7.1. After completion of the dropwise addition, the mixed solutions were stirred at the condition of 50° C., 300 rpm for 24 hours. Thereafter, it was washed with pure water, and only the precipitated powder was separated by centrifugation. The obtained powder was dried for 48 hours at 120° C., thereafter crushed with agate mortar, to obtain a powder of the first compound containing Mn, Ni and Co.

### 1.1.2 Mixing

The first compound powder, Na₂CO₃ as the second compound, and Al(NO₃)₃.9H₂O as the third compound were mixed to obtain a mixed powder having a composition after firing of Na_{0.67}Mn_{0.5}Ni_{0.2}C_{0.2}Al_{0.1}O₂.

### 1.1.3 Firing

The mixed powder was pressed under 2 ton load by cold isotropic pressure method to produce pellets. The obtained pellets were pre-fired at 600° C. for 6 hours in an air atmosphere, thereafter main fired at 900° C. for 24 hours, to synthesize a Na-containing oxide (Na_{0.67}Mn_{0.5}Ni_{0.2}Co_{0.2}Al_{0.1}O₂) having a P2 type structure.

### 1.1.4 Ion Exchange

LiNO₃ and LiCl were mixed at a mass ratio of 88:12 to give a mixed salt. The obtained mixed salt and Na-containing oxide described above were weighed so that the molar ratio of Li contained in the mixed salt to Na-containing oxide described above was 2 times. Ion-exchange was carried out for 1 hour at 150° C. in an atmosphere after mixing the Na-containing oxide with the mixed salt. After ion-exchange, water was added to dissolve the salt, and water washing was further performed to obtain a Li-containing oxide having an O2 type structure as a positive electrode active material.

### 1.2 Example 2

Except that as the third compound, Mg(NO₃)₂·6H₂O was used instead of Al(NO₃)₃·9H₂O, and the first compound, the second compound and the third compound were mixed so as to be a Na_{0.67}Mn_{0.5}Ni_{0.2}Co_{0.2}Mg_{0.1}O₂ to obtain mixed powders, a Li-containing oxide having an O2 type structure as a positive active material was obtained in the same manner as in Example 1.

### 1.3 Comparative Example 1

Except that during co-precipitation synthesis of the first compound, Mn (NO₃)₂·6H₂O, Ni(NO₃)₂·6H₂O, and, Co(NO₃)₂·6H₂O, NO₃)₂·6H₂O was solved to be 5:2:3 in a molar ratio, and the first compound and the second compound, without the third compound, were mixed so as to be Na_{0.67}Mn_{0.5}Ni_{0.2}Co_{0.3}O₂ to obtain a mixed powder, a Li-containing oxide having an O2 type structure as a positive active material was obtained in the same manner as in Example 1.

### 1.4 Comparative Example 2

### 1.4.1 Preparation of the First Compound (Co-Precipitation Synthesis)

Mn(NO₃)₂·6H₂O, Ni(NO₃)₂·6H₂O, Co(NO₃)₂·6H₂O and Al(NO₃)₃·9H₂O as the raw materials were dissolved in pure water so that molar ratio of Mn, Ni, Co and Al was 5:2:2:1 to obtain a first solution. On the other hand, Na₂CO₃ was dissolved in pure water so as to have a concentration 12 wt % to obtain a second solution. The first solution and the second solution were dropped into a beaker at the same time, and the first compound was co-precipitated and synthesized. At this time, the dropping rate was controlled so that pH was 7.0 or more and less than 7.1. After completion of the dropwise addition, the mixed solutions were stirred under the condition of 50° C., 300 rpm for 24 hours. Thereafter, it was washed with pure water, and only the precipitated powder was separated by centrifugation. The obtained powder was dried for 48 hours at 120° C., thereafter crushed with agate mortar, to obtain a powder of the first compound containing Mn, Ni, Co and Al.

### 1.4.2 Mixing, Calcination and Ion Exchange

The first compound powder and Na₂CO₃ as the second compound were mixed so as to be Na_{0.67}Mn_{0.5}Ni_{0.2}Co_{0.2}Al_{0.1}O₂ to obtain a mixed powder. By using the obtained mixed powder, pressing, pre-firing and main firing were performed in the same manner as in Example 1 to synthesize a Na-containing oxide (Na_{0.67}Mn_{0.5}Ni_{0.2}Co_{0.2}Al_{0.1}O₂) having a P2 type structure, and ion-exchange was performed using the Na-containing oxide in the same manner as in Example 1 to obtain a Li-containing oxide having an O2 type structure as a positive electrode active material.

### 1.5 Comparative Example 3

Except that Mg(NO₃)₂·6H₂O was used instead of Al(NO₃)₃·9H₂O, a Na-containing oxide (Na_{0.67}Mn_{0.5}Ni_{0.2}Co_{0.2}Mg_{0.1}O₂) having a P2 type structure and a Li-containing oxide having an O2 type structure as a positive active material were obtained in the same manner as in

### Comparative Example 2

### 2. Identification of Chemical Composition and Crystal Structure of Positive Electrode Active Material

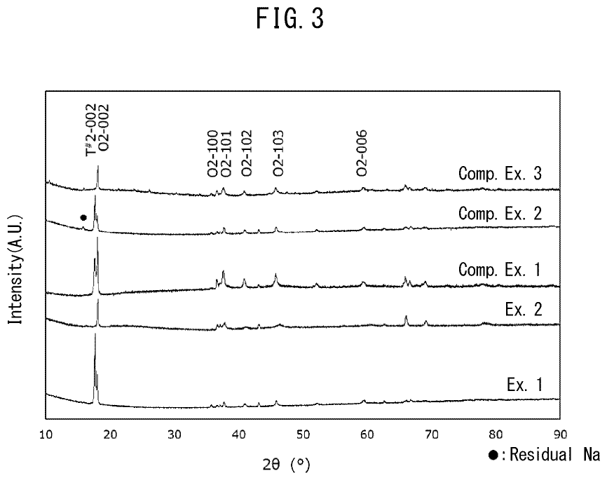

The chemical composition of the positive electrode active material of each of Examples 1 and 2 and Comparative Examples 1 to 3 was specified by ICP-AES. The results are shown in Table 1 below. As shown in Table 1, the target chemical composition was obtained. Further, X-ray diffraction measurement was performed on each of the positive electrode active materials. FIG. 3 shows the results. As shown in FIG. 3, all of the positive electrode active materials of Examples 1 and 2 and Comparative Examples 1 to 3 were confirmed to have an O2 type structure.

TABLE 1

| | Li | Mn | Ni | Co | Al | Mg |
|---|---|---|---|---|---|---|
| Ex. 1 | 0.67 | 0.50 | 0.20 | 0.21 | 0.09 | — |
| Ex. 2 | 0.66 | 0.50 | 0.20 | 0.21 | — | 0.09 |
| Comp. Ex. 1 | 0.68 | 0.50 | 0.20 | 0.30 | — | — |
| Comp. Ex. 2 | 0.68 | 0.50 | 0.20 | 0.21 | 0.09 | — |
| Comp. Ex. 3 | 0.65 | 0.50 | 0.21 | 0.21 | — | 0.08 |

### 3. Observation of Positive Electrode Active Material

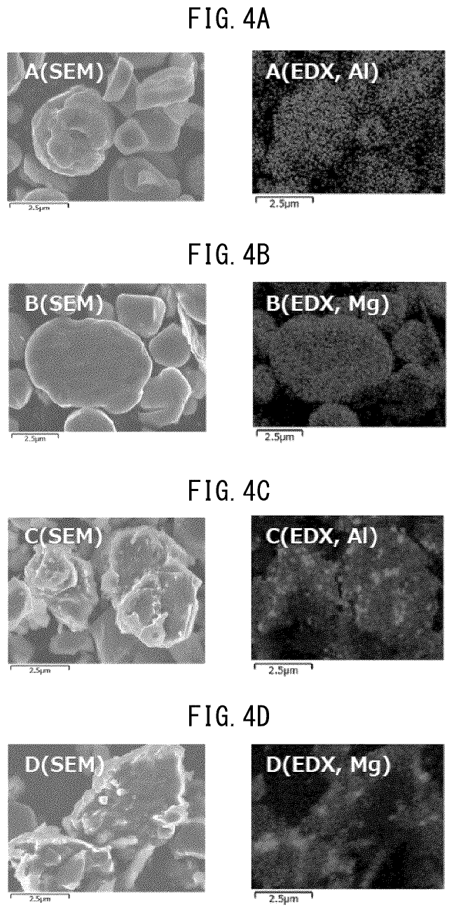

Each of the positive electrode active materials of Examples 1 and 2 and Comparative Examples 2 and 3 was observed by SEM-EDX. The results are shown in FIG. 4. “A” is the result according to Example 1, “B” is the result according to Example 2, “C” is the result according to Comparative Example 2, and “D” is the result according to Comparative Example 3. EDX images of Example 1 and Comparative Example 2 show the distribution state of Al, and EDX images of Example 2 and Comparative Example 3 show the distribution state of Mg. It can be seen from FIG. 4 that, on the surface of the positive electrode active material according to Comparative Examples 2 and 3, fine particles containing Al and Mg (circle equivalent diameter of 0.1 μm or more) are aggregated. The area of the aggregated area per 1.00 mm² surface of the positive electrode active material is greatly exceeding 0.01 mm². On the other hand, in the positive electrode active material according to Examples 1 and 2, it can be seen that Al and Mg are uniformly doped into the positive electrode active material in that there is substantially no aggregated region of Al or Mg on the surface of the positive electrode active material (per the surface 1.00 mm² of the positive electrode active material, the area of the aggregated region is less than 0.01 mm²).

### 4. Making Coin Cell

The above-mentioned positive electrode active material particles (powdered by ball milling process) 85 g and carbon black 10 g were added into 125 mL of n-methylpyrrolidone solution in which 5 g of polyvinylidene fluoride (PVdF) was dissolved, and uniformly kneaded to prepare a paste. This paste was coated on an Al foil having a thickness of 15 μm on one side with a basis weight 6 mg/cm² and dried to obtain a laminate having a positive electrode mixture layer on the Al foil. Thereafter, this laminate was pressed to obtain the thickness of the mixture layer of 45 μm, and the density of the mixture layer of 2.4 g/cm³. Finally, the laminate after pressing was cut out so as to be φ16 mm, to obtain a positive electrode. On the other hand, Li foil was cut out so as to be 19 mm to obtain a negative electrode. A CR2032 type coin cell was prepared using these positive and negative electrodes. Here, a porous separator made of PP was used as a separator, and a mixture of EC (ethylene carbonate) and DMC (dimethyl carbonate) in a volume ratio of 3:7 in which lithium hexafluoride phosphoric acid (LiPF₆) was dissolved in a concentration 1 mol/L as a support salt was used as an electrolytic solution

### 5. Evaluation of Initial Discharge Capacity and Charge/Discharge Cycle Characteristics

For the coin cell, the first discharge capacity and the capacity retention rate after 10 cycles of the charge and discharge at the charge and discharge rate of 0.1 C. The charge and discharge was set so as to be up to 4.8V of charge and down to 2.0 V of discharge for any of the cycles.

### 6. Evaluation of Charge/Discharge Rate Characteristics

The coin cell was charged in the voltage-range of 2.0-4.8V at 0.1 C, then discharged with 0.1 C, 0.5 C, 1 C or 5 C in a thermostatic bath held at 25° C., the discharge capacity at each rate was measured, and was evaluated by comparing the discharge capacity at 0.1 C as 100%.

### 7. Evaluation Results

Table 2 below shows the evaluation results for each of the initial discharge capacity of the coin cell, the charge and discharge cycle characteristics of the coin cell, and the charge and discharge rate characteristics of the coin cell.

TABLE 2

| | | Capacity | | | |
|---|---|---|---|---|---|
| | Initial | Retention | Rate Characteristics | | |
| | Discharge | Rate after | (ratio to Discharge | | |
| | Capacity | 10 Cycles | Capacity of 0.1 C) | | |
| | (0.1 C) | (0.1 C) | 0.5 C | 1 C | 5 C |
| Ex. 1 | 199 mAh/g | 97% | 90% | 86% | 64% |
| Ex. 2 | 188 mAh/g | 91% | 84% | 79% | 52% |
| Comp. Ex. 1 | 218 mAh/g | 80% | 68% | 59% | 28% |
| Comp. Ex. 2 | 181 mAh/g | 98% | 92% | 87% | 62% |
| Comp. Ex. 3 | 172 mAh/g | 93% | 85% | 77% | 51% |

It can be seen from the results shown in Table 1 that:
(1) The coin cell using the positive electrode active material according to Comparative Example 1 is inferior in cycle characteristics and rate characteristics. It is considered that the positive electrode active material according to Comparative Example 1 does not contain an element M such as Al or Mg which stabilizes a crystal structure, and the crystal structure is collapsed during charging and discharging, and thus, the cycling characteristics and the rate characteristics are deteriorated.
(2) The coin cells using the positive electrode active materials according to Comparative Examples 2 and 3 have a small capacity. It is considered that, in the positive electrode active material according to Comparative Examples 2 and 3, fine particles derived from Al or Mg are aggregated on the surface of the active material, and the area of deintercalation of Li ions in the positive electrode active material becomes small, which leads to a decrease in capacity.
(3) The coin cells using the positive electrode active materials according to Examples 1 and 2 are excellent in capacity, cycle characteristics and rate characteristics. In the positive electrode active materials according to Examples 1 and 2, it is considered that the crystalline structure is stabilized by Al or Mg and that fine particles derived from Al or Mg are not aggregated on the active material surface, which leads to both of the capacity, the cycling characteristics and the rate characteristics.

In the above examples, a case in which the first compound is obtained by co-precipitation synthesis has been exemplified, but a method of obtaining the first compound is not limited thereto. In addition, in the above example, a case in which the first compound, the second compound, and the third compound are mixed by powder mixing has been exemplified, but the method of mixing the compound is not limited thereto. In addition, in the above examples, a case in which a Li-containing oxide having a particular chemical composition is used as a positive electrode active material has been exemplified, but the chemical composition of the positive electrode active material is not limited thereto.

### REFERENCE SINGS LIST

10 Positive electrode active material layer
20 Electrolyte layer
30 Negative electrode active material layer
40 Positive electrode current collector
50 Negative electrode current collector
100 Lithium ion battery

1. A method of manufacturing a positive electrode active material, the method comprising:
obtaining a first compound including at least one element of Mn, Ni and Co;
mixing
the first compound,
a second compound including Na and
a third compound including at least one element M selected from B, Mg, Al, K, Ca, Ti, V, Cr, Cu, Zn, Ga, Ge, Sr, Y, Zr, Nb, Mo and W,
to obtain a mixture;
firing the mixture to obtain a Na-containing oxide having a P2 type structure; and
ion-exchanging at least a portion of Na of the Na-containing oxide to Li to obtain a Li-containing oxide having an O2 type structure.

2. The method according to claim 1, the method comprising:
obtaining a precipitate as the first compound by a co-precipitation method using an ion source and a transition metal compound, wherein the ion source is capable of forming a precipitate with transition metal ions in an aqueous solution.

3. The method according to claim 1, wherein
the first compound is a salt including at least one element of Mn, Ni and Co,
the second compound is a salt including Na, and
the third compound is a salt including the element M.

4. The method according to claim 1, wherein
the Li-containing oxide has a chemical composition represented by LiₐNa_{b}Mnₓ₋ₚNi_{y-q}Co_{z-r}M_{p+q+r}O₂ (where, 0<a≤1.00, 0≤b≤0.20, x+y+z=1, 0.03≤p+q+r<0.17).

5. A positive electrode active material having an O2 type structure, wherein the positive electrode active material has a chemical composition represented by LiₐNa_{b}Mnₓ₋ₚNi_{y-q}CO_{z-r}M_{p+q+r}O₂ (where, 0<a≤1.00, 0≤b≤0.20, x+y+z=1, 0.03≤p+q+r<0.17, M is at least one selected from B, Mg, Al, K, Ca, Ti, V, Cr, Cu, Zn, Ga, Ge, Sr, Y, Zr, Nb, Mo and W), and
the ratio of aggregation areas of the element M occupying a surface of the positive electrode active material is less than 0.01 mm² per 1.00 mm² of the surface.
